(19) United States
(12) Patent Application Publication
(10) Pub. No.: US 2025/0337880 A1
(43) Pub. Date: Oct. 30, 2025

(54) APPLICATIONS OF TEMPLATE MATCHING IN VIDEO CODING

(71) Applicant: DOLBY LABORATORIES LICENSING CORPORATION, San Francisco, CA (US)

(72) Inventors: Jeeva Raj Arumugam, Rasipuram (IN); Jay Nitin Shingala, Bangalore (IN); Ashwin Natesan, Bangalore (IN); Manasi Mahendra Remane, Pune (IN); Taoran Lu, Santa Clara, CA (US); Fangjun Pu, Sunnyvale, CA (US); Peng Yin, Ithaca, NY (US)

(73) Assignee: DOLBY LABORATORIES LICENSING CORPORATION, San Francisco, CA (US)

(21) Appl. No.: 18/855,268

(22) PCT Filed: Apr. 5, 2023
(86) PCT No.: PCT/US2023/017535

§ 371 Date: Oct. 8, 2024

(30) Foreign Application Priority Data
Apr. 12, 2022 (IN) 202241021946

(51) Int. Cl. H04N 19/105; H04N 19/169; H04N 19/176; H04N 19/96

(52) U.S. Cl. CPC H04N 19/105; H04N 19/176; H04N 19/1883; H04N 19/96

(57) ABSTRACT

Methods are described for template matching (TM) in video coding. The proposed methods include: the use of constrained top and left neighbors in template matching, enabling TM only in coding tree unit boundaries, using approximated reconstructed samples, a new processing pipeline for deriving decoder side intra mode derivation (DIMD) combined with template based intra mode derivation (TIMD), and using filtered pixels from the neighbors, instead of using the reconstructed pixels. Furthermore, methods are described on how template matching may be applied in combination with Intra, sub-partitioning mode, interpolation filtering in intra prediction, block partitioning, bi-prediction with coding unit-level weights, and adaptive motion vector resolution.

### CROSS-REFERENCE TO RELATED APPLICATIONS

This application claims priority of Indian Provisional Patent Application No. 202241021946 filed Apr. 12, 2022, which is incorporated by reference in its entirety.

### TECHNOLOGY

The present document relates generally to images and video coding. More particularly, an embodiment of the present invention relates to applications of template matching in video coding.

### BACKGROUND

In 2020, the MPEG group in the International Standardization Organization (ISO), jointly with the International Telecommunications Union (ITU), released the first version of the Versatile Video Coding Standard (VVC), also known as H.266 (Ref. |7|). More recently, the same group has been working on the development of the next generation coding standard that provides improved coding performance over existing video coding technologies. As part of this investigation, new coding techniques are also examined.

As appreciated by the inventors here, improved techniques for applying template matching in image and video coding are desired, and they are described herein.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts an example of template matching in video coding; and

FIG. 2 depicts an example subdivision of a picture for processing coding units according to an embodiment of this invention.

### DESCRIPTION OF EXAMPLE EMBODIMENTS

Example embodiments that relate to applying template matching in video coding are described herein. In the following description, for the purposes of explanation, numerous specific details are set forth in order to provide a thorough understanding of the various embodiments of present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to template matching (TM) in image and video coding. The proposed methods include: the use of constrained top and left neighbors in template matching, enabling TM only in coding tree unit boundaries, using approximated reconstructed samples, a new processing pipeline for deriving decoder side intra mode derivation (DIMD) combined with template based intra mode derivation (TIMD), and using filtered pixels from the neighbors instead of using the reconstructed pixels. Furthermore, example embodiments describe how template matching may be applied in combination with intra mode, sub-partitioning mode, interpolation filtering in intra prediction, block partitioning, bi-prediction with coding unit-level weights, and adaptive motion vector resolution.

### Template Matching in Video Coding

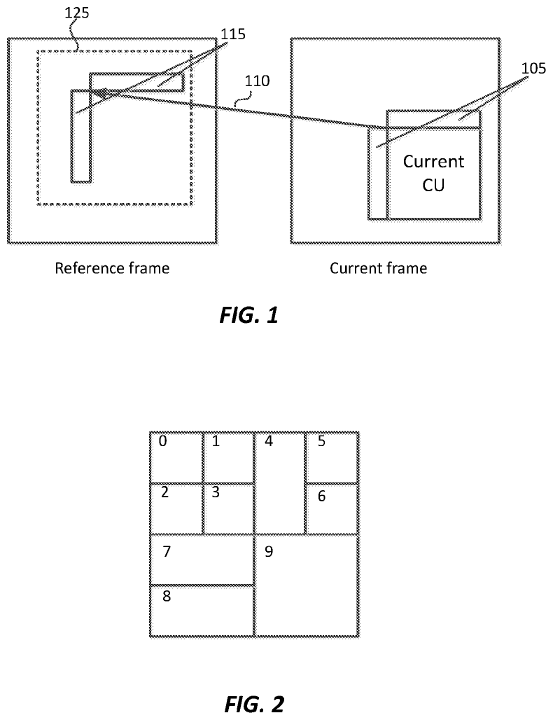

FIG. 1 depicts an example of template matching (TM) in video coding (Ref. [1]). The term “template matching” refers to a decoder-side, motion vector (MV) derivation method to refine the motion information of the current coding unit (CU) by finding the closest match between a template (i.e., top and/or left neighbouring blocks (105) of the current CU) in the current picture and a block (i.e., same size to the template) in a reference picture. As illustrated in FIG. 1, in an embodiment, given an initial motion vector (110), a better MV is to be searched around the initial motion vector of the current coded unit (CU) within a [−8, +8]-pel search range (125). The search step size is determined based on the advanced motion vector resolution (AMVR) mode and TM can be cascaded with a bilateral matching process in merge modes.

In advanced motion vector prediction (AMVP) mode, a motion vector predictor (MVP) candidate is determined based on template matching error to pick up the one which reaches the minimum difference between the current block template (105) and the reference block template (115), and then TM performs only for this particular MVP candidate for MV refinement. TM refines this MVP candidate, starting from full-pel motion vector difference (MVD) precision (or 4-pel for 4-pel AMVR mode) within a [−8, +8]-pel search range (125) by using an iterative diamond search. The AMVP candidate may be further refined by using cross search with full-pel MVD precision (or 4-pel for 4-pel AMVR mode), followed sequentially by half-pel and quarter-pel ones depending on the AMVR mode. This search process ensures that the MVP candidate continues to keep the same MV precision as indicated by the AMVR mode after the TM process.

In merge mode, a similar search method is applied to the merge candidate indicated by the merge index. TM may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

As appreciated by the inventors, in the current version of the Inter template matching tool the following observations can be made:
1) Refined motion vectors (MVs) from neighbor blocks are needed to start the current block MV prediction
2) Current template pixels (e.g., 4 lines from top and left) are needed, which are the reconstructed pixels from the neighboring blocks
3) VVC uses current pixels in the reshaped domain for Intra prediction, but when one uses the current reconstructed pixels for template matching, inverse reshaping is needed to return back to the original domain, because the reference template pixels are in the original domain
4) The boundary strength calculation process needs to be delayed in the HW pipeline design because refined MVs are used

In addition to the inter template matching tool, the idea of template matching is also being widely exploited by other coding tools, to help making decisions at the decoder side by finding the closest match between a template (i.e., top and/or left neighboring blocks of the current CU) in the current area and a reference area. Examples include:
1) Intra Template Matching (Ref. [2]): a special intra prediction mode that copies the best prediction block from the reconstructed part of the current frame, whose L-shaped template matches the current template.
2) Template based Intra Mode Derivation using most probable modes (MPMs) (TIMD) (Ref. [3]): This is an intra mode derivation method using most probable modes (MPMs) with the neighboring template. The TIMD mode is used as an additional intra prediction method for a CU.
3) Adaptive re-ordering of merge candidates (ARMC) with TM (Ref. [4]): In this tool, after a merge candidate list is constructed, merge candidates are divided into several subgroups. Merge candidates in each subgroup are reordered ascendingly according to cost values based on template matching.
4) MVD sign prediction using TM (Ref. [5]): Here, motion vector difference sign prediction can be applied in regular inter mode if the motion vector difference contains non-zero component. Possible MVD sign combinations are sorted according to template matching cost, and an index corresponding to the true MVD sign is derived and coded with context model.
5) TM with merge mode with motion vector difference (MMVD) (Ref. [5]): This is a template matching based reordering method for extended MMVD.

Embodiments presented here aim at improving the template matching process from different aspects:
1) Proposals for quality improvement (QI): Aiming at improving compression efficiency, preferably without any additional hardware (HW) implementation issues as compared to current coding tools.
2) Proposals to get rid of HW dependency/pipeline issues (HWPI) and for hardware/software (HW/SW) complexity reduction (CR): Aiming at solving the HW dependency/pipeline issues and harmonization of similar tools by considering certain guidelines, and HW/SW friendly solutions like complexity reduction with minimal impact on compression efficiency
3) Extend the TM concept to other coding tools.

### Use of Constrained Top or Left Neighbor for TM so as to Reduce the Dependency of Immediate Neighbor in Decoding Order

Motivation: TM needs immediate top and left neighbor reconstructed pixels for the template. This introduces a strong pipeline dependency in the decoding pipeline as the reconstructed pixels of the immediate neighbor are needed for deriving the motion information of the current CU.

Proposal 1: Disallow neighbor samples from immediately previous CU for TM as follows:
Use the top CU for TM if left CU was immediately previous CU in decode order. For example. In FIG. 2, CU 3 would use top samples (CU 1) for computing neighbor cost but not the left samples (CU 2), which was its immediate previous CU in decoder order. Similarly, CU 9 can use all the top neighbor samples but can use only partial left neighbor samples from CU 7, as the left neighbor samples from CU 8 belong to immediately previous CU in decode order
Use the left CU for computing the neighbor cost if top CU was immediately previous CU in decode order. For example, in FIG. 2, CU 6 can use left neighbor samples from CU 4 for TM but not the top neighbor samples from CU 5 which is the immediate previous CU in decode order.

Proposal 2: Disallow neighbor samples from ‘X’ (X>1) number of previous CUs for TM.

This is an extension of proposal 1 wherein the neighbor samples from multiple previous CUs in the decoding order are prohibited for TM to provide more HW parallelism. This is suggested as TM is a relatively complex tool with many stages of search and refinement. If neither the left nor the top neighbors can be used due to this constraint, TM has to be fully implicitly disabled for such CUs. For instance, if X=2,
CU 9 can use only top samples in FIG. 2
On the other hand, CU 3 and CU 6 in FIG. 2 can't use left or top samples, hence TM is implicitly disabled for them.

Proposal 3: Disallow neighbor samples from a specific area size of previous CUs for TM. This is similar to proposal 2, but the number of CUs prohibited may be a variable instead of being a constant value X.

TM Enabled Only at CTU Boundaries with Constraints on Left Neighbor Usage

The proposal it to enable TM only at coding tree unit (CTU) boundaries to enable virtual pipeline data unit (VPDU) level parallelism for TM as follows:
Top CTU neighbor samples are always available (except for frame boundaries).
Usage of left CTU neighbor samples is allowed only if the following conditions are met:
   Current CTU root node is split into quad-tree (QT) (N×N) or horizontal binary tree (BT) (2N×N)
   Left CTU root node is split into QT (N×N) or horizontal BT (2N×N)
   This ensures TM for 4 N×N VPDUs in CTU to be pipelined as follows:
      VPDU0 boundary samples of current CTU can use VPDU1 of left CTU for left neighbor samples as well as top CTU samples
      VPDU2 boundary samples of current CTU can use VPDU3 of left CTU for left neighbor samples, but top samples cannot be used
      VPDU1 boundary samples can use only top CTU samples for TM
      VPDU3 cannot use TM
   Note that CUs which are not part of either top or left CTU boundary cannot use TM.

### TM Using Approximated Reconstruction Samples of Top and Left Inter Prediction CUs

Motivation is to use approximated reconstructed samples of neighbor inter CUs for TM. The approximated reconstructed samples of neighbors are derived by adding filtered (e.g., bilinear interpolated) prediction samples and the look up table (LUT) based inverse transformed residue of dominant transform coefficients (top 4 or top 8).

TM causes significant hardware pipeline delays for inter reconstruction because it introduces the dependency to use reconstructed neighboring samples. The current CU needs to wait for its top and left CUs to finish reconstruction (e.g., allow for reconstruction samples to be available for use) before it can start the TM process. This proposal aims at reducing the pipeline delay, by replacing the use of reconstructed samples with approximated reconstructed samples, so that the current CU can start the TM process once the prediction and dequantized transform coefficients of neighbors are available. In simplified terms:

$$ReconSample\_Approximated = Pred + Res ,$$

where Pred denotes predicted pixels, and Res=InvT(QuantCoeff), where InvT(QuantCoeff) denotes the inverse transform of quantized coefficients, and

$$ReconSample\_Approximated = filtered ( Pred ) + LUT \vert QuantCoeff \vert .$$

The LUT-based operation on dequantized transform coefficients is a fast approximation to estimate the residue without performing actual inverse transform. The idea of using filtering on prediction is like the motivation on adaptive loop filtering (ALF), to improve the accuracy of approximation. But for complexity reduction consideration, the filtering to be applied here should not be too complex.

For the case of luma mapping, chroma scaling (LMCS), when enabled in VVC, inter prediction is in the original domain and reconstruction and residues are in the reshaped domain, so a mapping operation (LMCSFwdMap) is needed. Filtering of prediction can be used in either domain.

$$\begin{matrix}Recon Sample = Actual = LMCSFwd Map [ Pred ] + Res , \\ where Res = InvT ( QuantCoeff ) . \\ ReconSample\_Approximated = filtered ( PRed ) + LUT [ QuantCoeff ] , \\ where \\ filtered ( Pred ) = filtered ( LMCSFwd Map [ Pred ] ) or LMCSFwd Map [ filtered ( Pred ) ] .\end{matrix}$$

The following restrictions/modifications can be further applied to reduce TM complexity:
TM uses 4 neighbor samples while sign prediction uses 2 neighbor samples.
   One can harmonize both TM and sign prediction to use only two neighbor samples to reduce overhead of approximate reconstruction of inter CUs using LUT
Another option is to use only inter prediction samples of left and top for Inter TM (without the approximated residue).
   This assumes inter CUs have less residue (less number of small coded coefficients) and hence the prediction has most of the information of the reconstructed CU.
   To enforce this assumption, one can also apply constraints, such as: use inter prediction samples of neighbor CUS which have few coded coefficients (say, less than 3 coefficients) coded in neighbor CU

### Restricted Usage of TM Refined MVs for Merge and MV List Construction Process

Motivation: Usage of TM based MV or merge modes introduces a strong pipeline dependency in the decoding pipeline as the reconstructed pixels of the immediate neighbor is needed for deriving the merge list/AMVP list of current CU, which makes almost all HW decode operations serialized at CU level.

Proposal: Restrict usage of TM refined MVs for motion vector prediction process, such as merge list and AMVP list construction, as follows:
1. Use TM refined motion only at CTU boundaries only from top, top left and top right CTU. Pre-TM motion information to be used for other spatial neighbors
2. The TM refined MVs can be used for other forward dependencies such as boundary strength (BS) calculations and Temporal MV storage.
3. Tools such as ARMC, TM with MMVD, TM with MVD sign, and the like, would have to be fully disabled or enabled only at TOP CTU boundaries.
   Harmonization of Intra prediction process across DIMD and TIMD

Motivation: Decoder-side intra mode derivation (Ref. [6]) is a new tool in the current enhanced compression model (ECM) in JVET. The DIMD process uses the fusion of three intra modes, and TIMD uses either one mode or fusion of two intra modes. TIMD uses DIMD modes to decide the best mode based on template cost, hence TIMD process is the worst case in terms of HW processing latency. Harmonizing the aspects of DIMD and TIMD, such that it helps to either improve compression efficiency or reduce the HW complexity. In ECM, the following simplified notation may be used to describe the computation engines needed for the DIMD and TIMD modes:
C0: MPM list derivation
Input: Neighbor Intra modes
Output: Set of modes
C1: Histogram of gradients and find set of intra modes from the amplitude of histogram of gradients
Input: Current neighbor reconstruction pixels
Output: Top two Intra modes based on TM cost
C2: Compute the TIMD cost for the given set of intra modes and select the top 2 intra modes
Input: Current neighbor reconstruction pixels and the set of Intra modes
Output: Top two Intra modes based on TM cost
C3: Fusion of 3 intra modes (one is fixed to be planar)
Input: Two intra modes and a planar mode
Output: Final Intra prediction data
C4: Fusion of 2 intra modes
Input: Two intra modes
Output: Final Intra prediction data
Current method in ECM:
   DIMD mode: C1+C3
   TIMD mode: C0+C1+C2+C4
Proposal 1
   DIMD mode: C1 (set of N modes)+C2+C4
   TIMD mode: C0+C1 (only 2 modes)+C2+C4
Proposal 2
   DIMD mode: C1 (set of N modes)+C2+C3
   TIMD mode: C0+C1 (only 2 modes)+C2+C3
      The term “N Modes” denotes N intra prediction modes, such as the angular modes, DC mode, planar mode, and the like.

### Reducing the On-Chip Memory for Intra TM

Motivation: On-chip memory requirement for Intra TM is very high as compared to Intra block copy (IBC). The current Intra template matching technique in ECM uses top pixels from several top CTU rows in case the current CU size is large.

Proposal: Restrict the usage of current reconstructed pixels from top CTU rows. 4 bottom lines of reconstructed pixels from the top CTU can be allowed as this is already used for TM or intra prediction. Restrict the on chip memory size to a*CTU size, where scaler a can be 1 to 5.

### Using Filtered Prediction as a Substitute for Neighbor Reconstructed Pixels

Motivation: TM needs top and left neighbor reconstructed pixels for template construction. This introduces a strong pipeline dependency in the decoding pipeline as the reconstructed pixels of the neighbors are needed for deriving the motion information of current CU.

Proposals: For template construction, one can use the neighbor's prediction, albeit a filtered version, instead of the reconstructed pixels. The filter, which in an embodiment, can be a Wiener filter, can be derived using the statistical properties of the prediction and reconstruction pixels from the region in the reference frame pointed to by the unrefined MV. This process shall only be applied if at least one of the neighbors is inter coded. This proposal aims to find a suitable substitute for using reconstructed pixels from the neighbors. The prediction of the neighbor can be considered as a noisy version of the neighbor's reconstruction. Hence, if one was to find a linear filter to apply on the prediction such that difference between the filter's output and the actual reconstructed pixels is minimized, one would have found an optimal substitute, assuming one is constrained by a linear filter. For example, in FIG. 1, template 105 may be filtered as it is the hardware pipeline bottleneck. (In contrast, in template 115, all reconstructed samples are already available). TM needs to use reconstructed samples for 105 (the InterRecon happens in a late pipeline stage). The proposal is to use a filtered version of prediction in 105 to replace reconstruction of 105, so TM for current CU can start right after neighboring CUs have prediction samples available which happens in early pipeline stage. For example,

$$ReconSample\_Approximated = f ( Pred ) ,$$

where f( ) is some sort of filtering operation, such as a Wiener filter, a nonlinear filter, a neural network based filter, and the like.

The filter coefficients shall be derived using reconstruction pixels from the reference region pointed to by the unrefined TM MV as the reference signal and the prediction from the same region as the noisy version of the reference signal.

A few variants of this proposal which handle various complexities implied by the paragraph above are listed below:
1) Instead of deriving a filter for every TM call, one may signal a set of pre-defined filters via the adaptation parameter set (APS) and define a process for deriving a filter index based on the prediction and reconstruction statistics, or some other property.
2) Since usage of neighbor's prediction implies waiting for the neighbor CU's motion compensation (MC), which would entail waiting for refined MV output by neighbor CU's TM and similar MV refinement algorithms, use the MV prior to the start of MV refinement for deriving neighbor prediction used by the current CU for template construction.

### Harmonization of ARMC and TM

Motivation: To improve the coding efficiency of ARMC. An improved ARMC compensates for any coding efficiency loss by removing TM refinement.

Proposal: Adaptive reordering of merge candidates with TM refinement (ARMC-R), which in an embodiment includes the following steps:
Start with ARMC-TM, which brings already reference data for each merge candidate. In current ARMC, a reference template region of top and left is used, where the top reference template region size is (BlkWidth×4) and a left reference template region size is (4×BlkHeight).
In an embodiment, one can improve upon it by adding pixels around the reference template so that +/−1 MV refinement can be performed. So, the top reference template region size will be ((BlkWidth+2)×(4+2)) and the left template region will be ((4+2)×(BlkHeight+2)). “+2” indicates additional lines of pixels around the reference template region for +/−1 MV refinement. “+4” will be needed for +/−2 MV refinement.
9 point (including center, square pattern) integer pixel distance cost will be evaluated. Error surface based sub-pixel cost can also be derived from the 9 point cost, as used in decoder-side, motion vector refinement (DMVR) in VVC.
Instead of merge MV TM cost, choose the least cost from the 9 point refinement for each merge candidates
Reorder the merge list based on the least refined cost.
Remove duplicate MVs.
   Method 1: (QI) Replace ARMC-TM with proposed ARMC-R.
   Method 2: (CR) Remove TM refinement on top of method 1, because method 1 already covers the refinement.
   Simplification of TM based MV refinement for integer pixel refinement

Motivation: Template matching based MV refinement method is highly sequential involving interpolations and template cost computation using diamond pattern followed by last one step of cross.

Proposal: Use integer MV location corresponding to the motion vectors from merge/AMVP list as the starting point of search. It helps to avoid the interpolation need for Integer pixel refinement.

Search range will be restricted to an optimal value such that TM cost for all integer pixel location around center can be computed in parallel. For search range of +/−2 pixel around the center, TM cost needs to be computed for 25 points totally, for a search range of +/−3 pixel around the center, TM cost needs to be computed for 49 points.

### Extension of TM Concept to Other Tools

Intra sub-partition mode (ISP) plus TM: In VVC, Intra predicted blocks can be subdivided either horizontally or vertically into smaller blocks called sub-partitions. On each of them, the prediction and transform coding operations are performed separately, but the intra mode is shared across all sub-partitions. In an embodiment, it is proposed to combine ISP with TM to allow each sub-partition to have a different intra mode. The basic idea is to use TM to refine the shared intra mode for each sub-partition using either neighbouring angular intra prediction modes, or the most probable mode (MPM) modes for this block partition.

Interpolation filtering in intra prediction plus TM: In VVC, interpolation filtering is applied to fractional-slope modes. For luma, the interpolation filter either represent a 4-tap DCT-based interpolation filter (DCTIF) or a 4-tap smoothing interpolation filter (SIF). The type of the interpolation filter is not signaled in the bitstream and is determined based on the size of the block and intra prediction mode index. In an embodiment, one approach is to use TM to decide which IF should be used without explicit signaling. One can also add more candidate IFs in the pools, such as 8-tap DCTIF or SIF, and let TM decide which to use for best coding efficiency.

Block partitioning plus TM: For a given CU, one can use TM to find the best integer MV. Then one can copy the block partition from the best MV as the inferred partition for the current block. This is to save the bits for partition.

BCW (bi-prediction with CU level weights) plus TM: In VVC, for BCW, a set of weighting value candidates can be selected for bidirectional inter prediction. The index of the selected weighting values is signaled for AMVP mode and inherited for merge mode, if allowed. In an embodiment, one can improve BCW in two aspects by TM: 1) using TM to avoid signaling the weight index; 2) allow more weights and use TM to select a limited set to signal.

Adaptive motion vector resolution with TM: Instead of explicit signaling motion vector resolution, the resolution can be inferred based on TM. Basically for TM, different motion vector resolution (MVR) techniques can be tried, and the resolution with best MV is the resolution for the current CU.

### REFERENCES

Each one of the references listed herein is incorporated by reference in its entirety. The term JVET refers to the Joint Video Experts Team of ITU-T SG 16 WP 3 and ISO/IEC JTC 1/SC 29.
[1] JVET-U0100, “Compression efficiency methods beyond VVC,” Y.-J. Chang et al., teleconference, January 2021.
[2] JVET-V0130, “EE2: Intra Template Matching,” K. Naser et al., teleconference, April 2021.
[3] JVET-V0098, “EE2-related: Template-based intra mode derivation using MPMs,” Y. Wang et al., teleconference, April 2021.
[4] JVET-W0090, “EE2-3.1/EE2-3.2: Adaptive Reordering of Merge Candidates with Template/Bilateral Matching,” N. Zhang et al., teleconference, July 2021.
[5] JVET-Y0067, “EE2-3.9 and EE2-3.10: TM based reordering for MMVD and affine MMVD and MVD sign prediction,” M. Salehifar et al., teleconference, January 2022.
[6] JVET-O0449, “Non-CE3: Decoder-side Intra Mode Derivation (DIMD) with prediction fusion using Planar,” M. Abdoli et al., Gothenburg, July 2019.
[7] “Versatile Video Coding,” Rec. ITU-T H.266, August 2020.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to applying template matching in image and video coding, such as those described herein. The computer and/or IC may compute any of a variety of parameters or values that relate to applying template matching in image and video coding described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to applying template matching in image and video coding as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### EQUIVALENTS, EXTENSIONS, ALTERNATIVES AND MISCELLANEOUS

Example embodiments that relate to applying template matching in image and video coding are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method to process one or more pictures using template matching, the method comprising:
receiving a picture with a current coded unit (CU) and prior decoded coded units; and
applying template matching using neighbor pixel areas of the current CU, wherein in template matching, neighbor CUs are constrained as follows:
use a top CU for computing neighbor cost if a left CU was immediately previous CU in decode order;
use the left CU for computing neighbor cost if the top CU was immediately previous CU in decode order; or
disallow neighbor samples from X (X>1) number of previous CUs.

2. A method to process one or more pictures using template matching, the method comprising:
receiving a picture with a current coded unit (CU) and prior decoded coded units; and
applying template matching using neighbor pixel areas of the current CU, wherein template matching is constrained at a coding tree unit (CTU) as follows:
top CTU neighbor samples are always available (except for frame boundaries);
usage of left CTU neighbor samples is allowed only if the following conditions are met:
current CTU root node is split into quad-tree (QT) (N×N) or horizontal binary tree (BT) (2N×N); and
left CTU root node is split into QT (N×N) or horizontal BT (2N×N).

3. A method to process one or more pictures using template matching, the method comprising:
receiving a picture with a current coded unit (CU) and prior decoded coded units; and
applying template matching using neighbor pixel areas of the current CU, wherein in template matching, samples of neighbor CUs are derived based on using one or more of: filtered predicted samples or approximated residuals.

4. A method to process one or more pictures using template matching, the method comprising:
receiving a picture with a current coded unit (CU) and prior decoded coded units; and
applying template matching using neighbor pixel areas of the current CU, wherein in template matching only inter-predicted samples of neighbor CUs are used.

5. The method of claim 3, wherein a filter to generate the filtered predicted samples is derived using statistical properties of the prediction and reconstruction pixels from a region in a reference frame pointed to by an unrefined motion vector.

6. A method for decoder side intra mode derivation (DIMD) combined with Template based intra mode derivation (TIMD), the method comprising, computing:
a DIMD mode: by combining C1 (generate set of N modes), C2, and C4;
a TIMD mode: by computing C0, C1 (select only 2 modes), C2, and C4;
or computing:
a DIMD mode: by computing C1 (generate set of N modes), C2, and C3;
a TIMD mode: by computing C0, C1 (select only 2 modes), C2, and C3,
wherein C0, C1, C2, C3, and C4 comprise:
C0: MPM list derivation, with Input: Neighbor Intra modes, and Output: Set of modes;
C1: Histogram of gradients and find set of intra modes from the amplitude of histogram of gradients, with C1 Input: Current neighbor reconstruction pixels, and C1 Output: Top two Intra modes based on TM cost;
C2: Compute the TIMD cost for the given set of intra modes and select the top 2 intra modes, with C2 Input: Current neighbor reconstruction pixels and the set of Intra modes, and C2 Output: Top two Intra modes based on TM cost;
C3: Fusion of 3 intra modes (one is fixed to be planar), with C3 Input: two intra modes and a planar mode, and C3 Output: Final Intra prediction data;
C4: Fusion of 2 intra modes, with C4 Input: Two intra modes, and C4 Output: Final Intra prediction data.

7. A method for adaptive re-ordering of merge candidates (ARMC) with template matching, the method comprising:
performing adaptive re-ordering of merge candidates (ARMC) and a corresponding ARMC cost by enlarging a reference template by two or four lines of additional pixels for motion vector refinement;
computing 9 point refinement integer pixel distance costs;
instead of the ARMC cost select the least cost among the 9-point refinement costs as a minimum refined cost; and
reordering the merge candidates based on the minimum refined cost.

8. A method of applying template matching (TM) in video coding or decoding, the method comprising one or more of:
combining intra sub-partition mode (ISP) with TM, wherein each sub-partitions has its own intra mode, determined by applying TM to refine a shared intra mode using either neighbouring angular intra prediction modes, or the most probable mode (MPM) modes;
combining interpolation filtering in intra prediction with TM, wherein TM is applied to determine what interpolation filter to apply without explicitly signaling its identity index;
combining block partitioning with TM, wherein for a given coded unit (CU),
first, one can use TM to determine the best integer motion vector; and
subsequently copy the block partition from the best MV as the inferred partition for the current block;
combining BCW (bi-prediction with CU level weights) with TM, wherein instead of signaling weighting values candidates, these are selected via template matching; and
combining adaptive motion vector resolution with TM, wherein instead of explicit signaling motion vector resolution, the resolution can be inferred using template matching.

9. A non-transitory computer-readable storage medium having stored thereon computer-executable instructions for executing with one or more processors a method in accordance with claim 1.

10. An apparatus comprising a processor and configured to perform the method recited in claim 1.
